(19) United States
(12) Patent Application Publication
(10) Pub. No.: US 2008/0273192 A1
(43) Pub. Date: Nov. 6, 2008

(54) Vibration detection device

(75) Inventors: Kazutoshi Nomoto, Kanagawa (JP); Shoji Hirata, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/078,600

(22) Filed: Apr. 2, 2008

(30) Foreign Application Priority Data
May 1, 2007 (JP) 2007-121098

(51) Int. Cl. G01N 21/00; G01B 11/02

(52) U.S. Cl. 356/73; 356/499

(57) ABSTRACT

A vibration detection device capable of improving detection sensitivity when optically performing vibration detection is provided. A vibration detection device includes: a light source emitting a laser beam; an interferometer including a vibrating body and a first reflection body both capable of reflecting the laser beam, and a second reflection body capable of at least partially reflecting the laser beam, the interferometer splitting the laser beam emitted from the light source into beams traveling along first and second optical paths, the interferometer causing interference between a reference beam reflected by the first reflection body in the first optical path and reflected beams multiply reflected between the vibrating body and the second reflection body in the second optical path to form interference patterns; and a detection means for detecting the vibration of the vibrating body on the basis of the formed interference patterns.

### CROSS REFERENCES TO RELATED APPLICATIONS

The present invention contains subject matter related to Japanese Patent Application JP 2007-121098 filed in the Japanese Patent Office on May 1, 2007, the entire contents of which being incorporated herein by reference.

### BACKGROUND OF THE INVENTION

1. Field of the Invention

The present invention relates to a vibration detection device optically detecting the displacement of a vibrating body.

2. Description of the Related Art

In recent years, recording systems and the like using an SACD (Super Audio Compact Disc) or 24-bit/96 kHz sampling have been used, and a trend toward higher sound quality is becoming mainstream. In such a trend, analog microphone apparatuses in related arts have a limit to record sound specifically with a high frequency of 20 kHz or over, so in the case where contents are recorded by making use of reproduction of high-frequency sound as a characteristic of the above-described recording systems, the analog microphone apparatuses are a bottleneck.

Moreover, the dynamic range of the analog microphone apparatuses does not reach 144 dB which is allowed in 24-bit recording as a characteristic of the above-described recording systems, so the analog microphone apparatuses do not sufficiently exploit a wide dynamic range.

Further, at a recording site, in analog microphone apparatuses in related arts, noises are increased due to a long analog cable run length, or it is necessary to supply phantom power from a mixing console to a condenser microphone, so it causes an impediment to total digitization in a recording/producing system.

Therefore, in recent years, some digital microphone apparatuses have been proposed. For example, in Japanese Unexamined Patent Application Publication No. H10-308998, a digital microphone apparatus in which in an interferometer of the Mach-Zehnder type or the like, a digital audio signal output is obtained by converting a change in an interference pattern caused by the displacement of a microphone vibration film into a signal by a photoelectric conversion device, and digitally processing the signal has been proposed. Moreover, for example, in Japanese Unexamined Patent Application Publication No. H11-178099, a digital microphone apparatus in which in a Michelson interferometer, a bit stream signal is obtained by converting a change in an interference pattern caused by the displacement of a microphone vibrating plate into a signal by a photoelectric conversion device, and performing binary quantization of the value of the signal, and a vibration film driving means driving a microphone vibration film is included as a return path for constituting a so-called ΔΣ (delta sigma) converter has been proposed.

### SUMMARY OF THE INVENTION

In Japanese Unexamined Patent Application Publication No. H10-308998, a Mach-Zehnder interferometer or a Michelson interferometer is used to detect the vibration of a vibrating plate, thereby a digital audio signal is outputted.

On the other hand, in Japanese Unexamined Patent Application Publication No. H11-178099, a ΔΣ (delta sigma) converter including a vibrating plate is included. Therefore, it is considered that by the function of the ΔΣ converter, a 1-bit digital audio signal may be obtained with a simple configuration, and noises of audio signals in an audible band may be reduced by a noise shaving effect.

However, in Japanese Unexamined Patent Application Publication Nos. H10-308998 and H11-178099, the wavelength of a laser beam is approximately 0.6 μm, so there is an issue that it is difficult to remarkably improve detection sensitivity. Therefore, in the case where the vibration of a vibrating plate is large, the digital microphone apparatuses are effective; however, in the case where the digital microphone apparatuses are applied to high-sensitivity microphones which is necessary to detect a vibration of several pm to several tens of pm, it is difficult to detect the vibration of the vibrating plate, and there is room for improvement.

In view of the foregoing, it is desirable to provide a vibration detection device capable of improving detection sensitivity when optically performing vibration detection.

According to an embodiment of the invention, there is provided a vibration detection device including: a light source; an interferometer and a detection means. In this case, the interferometer includes a vibrating body and a first reflection body both capable of reflecting the laser beam, and a second reflection body capable of at least partially reflecting the laser beam, and the interferometer splits the laser beam emitted from the light source into beams traveling along first and second optical paths, and the interferometer causes interference between a reference beam reflected by the first reflection body in the first optical path and reflected beams multiply reflected between the vibrating body and the second reflection body in the second optical path to form interference patterns. Moreover, the detection means detects the vibration of the vibrating body on the basis of the formed interference patterns.

In the vibration detection device according to the embodiment of the invention, the laser beam emitted from the light source is split into two beams traveling along two optical paths (first and second optical paths) in the interferometer. At this time, a reference beam reflected by the first reflection body in the first optical path and reflected beams reflected by the vibrating body and the second reflection body in the second optical path interfere with each other to form the interference patterns. Then, the vibration of the vibrating body is detected on the basis of the interference pattern. In this case, the above-described reflected beams are beams multiply reflected between the vibrating body and the second reflection body in the second optical path, so the displacement of the vibrating body is accumulated according to the reflection number to cause an increase in an optical path difference between the reference beam and the reflected beams, thereby the displacement of the vibrating body is amplified to be detected.

In the vibration detection device according to the embodiment of the invention, the second reflection body may be a half mirror partially reflecting the laser beam and partially passing the laser beam therethrough.

In this case, in the case where the reflected beams include a plurality reflection components with different reflection numbers caused by multiple reflections between the vibrating body and the second reflection body, the optical path length of the second optical path for a reflection component with a desired reflection number among the plurality of reflection components with different reflection numbers is preferably set so as to be equal to the optical path length of the first optical path. In such a configuration, the visibility of the interference pattern formed by interference reaches its maximum, so selective interference between the reflection component with a desired reflection number and the reference beam is possible to occur. In addition, “equal” means not only literally equal but also substantially equal due to manufacturing variations or the like.

Moreover, in the case where the reflected beams include a plurality of reflection components with different reflection numbers caused by multiple reflections between the vibrating body and the second reflection body, the optical path length of the first optical path is preferably set so that the visibility peaks of the interference patterns caused by the interference between the reference beam and the plurality of reflection components are separated from one another. In such a configuration, it is easier to individually detect the visibility peak of each interference pattern.

In the vibration detection device according to the embodiment of the invention, the laser beam from the light source is split into two beams traveling along two optical paths (the first and second optical paths) in the interferometer, and the reference beam reflected by the first reflection body in the first optical path and the reflected beams reflected by the vibrating body and the second reflection body in the second optical path interfere with each other to form interference patterns, and the vibration of the vibrating body is detected on the basis of the interference pattern, so the vibration of the vibrating body is possible to be optically detected. Moreover, the above-described reflected beams are beams multiply reflected between the vibrating body and the second reflection body in the second optical path, so an optical path difference between the reference beam and the reflected beams is possible to be increased, and the displacement of the vibrating body is possible to be amplified to be detected. Therefore, when vibration detection is optically performed, detection sensitivity may be improved.

Other and further objects, features and advantages of the invention will appear more fully from the following description.

### BRIEF DESCRIPTION OF THE DRAWINGS

FIG. 1 is an illustration showing the whole configuration of a vibration detection device according to a first embodiment of the invention;

FIG. 2 is a sectional view showing an example of a specific configuration of a microphone capsule shown in FIG. 1;

FIG. 3 is a sectional view showing another example of a specific configuration of the microphone capsule shown in FIG. 1;

FIG. 4 is an illustration showing an example of a lissajous figure produced in a digital signal processing section shown in FIG. 1;

FIG. 5 is a plot showing a typical relationship between an optical path difference and visibility in an interferometer;

FIGS. 6A and 6B are plots showing a relationship between interfering beam peaks by a plurality of reflection components and visibility in the first embodiment;

FIG. 7 is a plot for describing interference between interfering beam peaks by a plurality of reflection components;

FIGS. 8A and 8B are sectional views showing multiple reflection modes according to a modification of the first embodiment; and

FIG. 9 is an illustration showing the whole configuration of a vibration detection device according to a second embodiment.

### DETAILED DESCRIPTION OF THE PREFERRED EMBODIMENTS

Preferred embodiments will be described in detail below referring to the accompanying drawings.

### First Embodiment

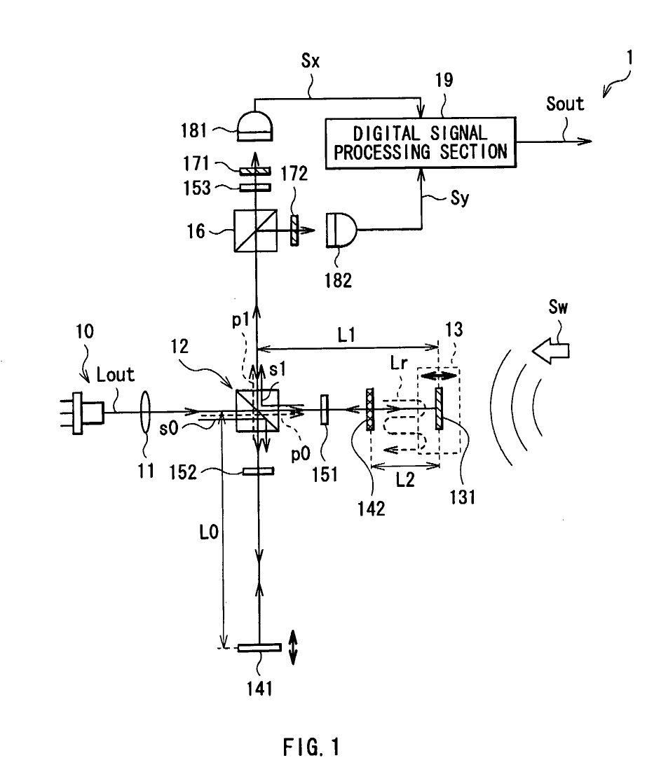

FIG. 1 shows the configuration of a vibration detection device (an optical microphone apparatus 1) according to a first embodiment of the invention. The microphone apparatus 1 outputs an audio signal Sout through the use of a vibration film (a vibration film 131 which will be described later) in response to a sonic wave Sw, and includes a laser source 10, a Michelson interferometer including the vibration film 131, a reflecting plate 141 and a half mirror 142, and a detection section outputting an output signal (the audio signal Sout) which is a digital signal.

The laser source 10 emits a laser beam Lout, and, for example, a self-pulsation laser diode with low coherence is used as the laser source 10. To reduce coherence, a laser diode modulated at high frequency may be used.

A lens 11 is a lens (a collimator lens) for collimating the laser beam Lout from the laser source 10.

### Configuration of Interferometer

The interferometer includes a polarizing beam splitter 12, the vibration film 131, the reflecting plate 141, the half mirror 142, three λ/4 plates 151 to 153, a beam splitter 16 and two polarizing plates 171 and 172.

The polarizing beam splitter 12 splits the laser beam Lout which is emitted from the laser source 10 and passes through the lens 11 into two components traveling along two optical paths, that is, a reflection optical path (a first optical path) to the vibration film 131 and a reference optical path (a second optical path) to the reflecting plate 141. More specifically, although the details will be described later, the polarizing beam splitter 12 is designed to make a P-polarized component p0 of the laser beam Lout and an S-polarized component s0 of the laser beam Lout go forward to the reflection optical path and the reference optical path, respectively. The laser beam Lout is split into the P-polarized component p0 and the S-polarized component s0 by approximately 50% each.

The vibration film 131 is displaced in response to the sonic wave Sw, and is made of, for example, the same vibration film with a gold-evaporated surface or the like as that used in a condenser microphone. The vibration film 131 is capable of reflecting the laser beam Lout (more specifically the S-polarized component s0) with high reflectivity, and as shown in FIG. 1, the vibration film 131 is contained in the microphone capsule 13. Moreover, as shown in FIG. 1, a distance between the vibration film 131 and the polarizing beam splitter 12 is denoted by L1. A specific configuration example of the microphone capsule 13 will be described later.

The reflecting plate 141 is capable of reflecting the laser beam Lout which is a reference beam (more specifically, the P-polarized component p0) with high reflectivity. As shown in FIG. 1, a distance between the reflecting plate 141 and the polarizing beam splitter 12 is denoted by L0, and as will be described later, the distance L0 is possible to be adjusted.

The half mirror 142 is arranged on the reflection optical path, more specifically between the polarizing beam splitter 12 and the vibration film 13. As shown in FIG. 1, a distance between the half mirror 142 and the vibration film 131 is denoted by L2. The half mirror 142 partially reflects the laser beam Lout (more specifically the S-polarized component so), and partially passes the laser beam Lout therethrough (for example, the half mirror 142 reflects 50% of the laser beam Lout and passes 50% of the laser beam Lout therethrough), thereby as shown in FIG. 1, multiple reflections of the laser beam Lout between the vibration film 131 and the half mirror 142 are possible to occur (that is, a multiply reflected beam Lr is generated).

The λ/4 plate 151 is arranged on the reflection optical path, more specifically between the polarizing beam splitter 12 and the half mirror 142. The λ/4 plate 152 is arranged on the reference optical path, more specifically between the polarizing beam splitter 12 and the reflecting plate 141.

As will be described later, the beam splitter 16 splits a S-polarized component s1 (a reflected beam) and a P-polarized component p1 (a reference beam) of the laser beam Lout which enter the beam splitter 16 via the polarizing beam splitter 12 into approximately 50% of each of the S-polarized component s1 and the P-polarized component p1 going forward to an optical path to the polarizing plate 171 and approximately 50% of each of the S-polarized component s1 and the P-polarized component p1 going forward to an optical path to the polarizing plate 172.

The polarizing plates 171 and 172 each are a polarizing plate having a polarizing axis in a direction different by 45° from each of the polarization direction of the entering S-polarized component s1 (the reflected beam) and the polarization direction of the P-polarized component p1 (the reference beam). Although the details will be described later, by such a configuration, in the polarizing plates 171 and 172, the S-polarized component s1 and the P-polarized component p1 interfere with each other to form interference patterns. The λ/4 plate 153 is arranged on an optical path between the beam splitter 16 and the polarizing plate 171.

By such a configuration, in the interferometer according to the embodiment, the laser beam Lout emitted from the laser source 10 is split into two components traveling along two optical paths (the first and second optical path). More specifically, the laser beam Lout is split into a component going forward to the second optical path (the reflection optical path) passing through the polarizing beam splitter 12, the λ/4 plate 151, the half mirror 142, the vibration film 131, the half mirror 142, the λ/4 plate 151, the polarizing beam splitter 12, the beam splitter 16, the polarizing plates 171 and 172 and the λ/4 plate 153, and a component going forward to the first optical path (the reference optical path) passing through the polarizing beam splitter 12, the λ/4 plate 152, the reflecting plate 141, the λ/4 plate 152, the polarizing beam splitter 12, the beam splitter 16, the polarizing plates 171 and 172 and the λ/4 plate 153. At this time, the beam (the S-polarized component s1, the reflected beam) reflected by the vibration film 131 via the λ/4 plate 151 in the reflection optical path, and the beam (the P-polarized component p1, the reference beam) reflected by the reflecting plate 141 via the λ/4 plate 152 in the reference optical path interfere with each other in the polarizing plates 171 and 172 to form the interference patterns.

### Configuration of Detection Section

The detection section includes two photoelectric conversion devices 181 and 182 and a digital signal processing section 19.

The photoelectric conversion devices 181 and 182 detect the interference patterns formed on the polarizing plates 171 and 172, respectively, to perform photoelectric conversion on the interference patterns, and then the photoelectric conversion devices 181 and 182 output signals Sx and Sy, respectively. The photoelectric conversion devices 181 and 182 each include, for example, a PD (a Photo Diode) or the like.

The digital signal processing section 19 performs AD (analog/digital) conversion of output signals Sx and Sy outputted from the photoelectric conversion devices 181 and 182, respectively, and outputs an output signal (the audio signal Sout) which is a digital signal. Such a digital counting method will be described in detail later.

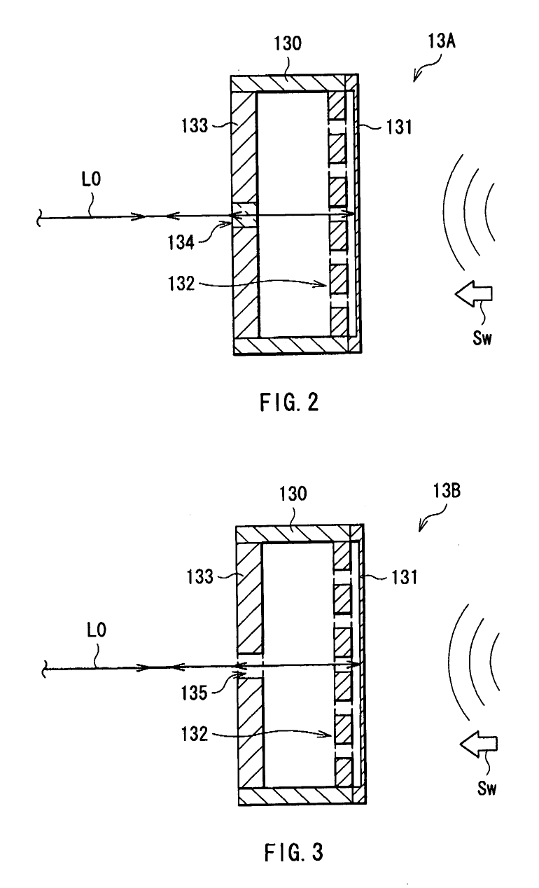

Next, referring to FIGS. 2 and 3, specific configuration examples of the microphone capsule 13 shown in FIG. 1 will be described below. FIGS. 2 and 3 show sectional views of microphone capsules 13A and 13B as the specific configuration examples of the microphone capsule 13.

The microphone capsule 13A shown in FIG. 2 includes an enclosure 130, the vibration film 131, a back electrode 132, a backplate 133 and a transparent member 134, and functions as an omnidirectional microphone capsule. The vibration film 131 is arranged on a side (a front side) where the sonic wave Sw enters, and the back electrode 132 is arranged on the back of the vibration film 131. The backplate 133 does not have an opening or the like so that the microphone capsule has a sealed configuration; however, a part of the backplate 133 is the transparent member 134 made of glass or a transparent resin forming an antireflection (AR) film. By such a configuration, in the microphone capsule 13A, while the sealed configuration for forming the omnidirectional microphone capsule is maintained, the laser beam Lout is possible to enter into the vibration film 131 via the transparent member 134 on the back side without preventing the entry of the sonic wave Sw.

On the other hand, the microphone capsule 13B shown in FIG. 3 includes the enclosure 130, the vibration film 131, the back electrode 132, the backplate 133 and an opening 135, and functions as a unidirectional microphone capsule. In the microphone capsule 13B, in a part of the backplate 133, an opening 135 for obtaining appropriate directivity by displacing the vibration film 131 by a difference between a sound pressure to be applied to the front side of the vibration film 131 and a sound pressure on the back side, and the laser beam Lout is possible to enter into the vibration film 131 via the opening 135. By such a configuration, in the microphone capsule 13B, through the use of the opening 135 for forming the unidirectional microphone capsule, the laser beam Lout is possible to enter into the vibration film 131 without preventing the entry of the sonic wave Sw.

The vibration film 131 corresponds to a specific example of “a vibrating body” in the invention, the reflecting plate 141 corresponds to a specific example of “a first reflection body” in the invention, and the half mirror 142 corresponds to a specific example of “a second reflection body” in the invention. Moreover, the photoelectric conversion devices 181 and 182 correspond to a specific example of “a couple of photoelectric conversion devices” in the invention, and the photoelectric conversion devices 181 and 182 and the digital signal processing section 19 correspond to a specific example of “a detection means” in the invention, and the digital signal processing section 19 corresponds to a specific example of “a figure producing means” and “a counter” in the invention.

Next, the operation of the microphone apparatus 1 according to the embodiment will be described in detail below.

At first, referring to FIGS. 1 to 4, the basic operation of the microphone apparatus 1 will be described below.

In the microphone apparatus 1, as shown in FIG. 1, the laser beam Lout is emitted from the laser source 10, and after the laser beam Lout is collimated by the lens 11, the laser beam Lout enters into the polarizing beam splitter 12. Then, the entering laser beam Lout is split into approximately 50% of the laser beam Lout going forward to the reflection optical path (the second optical path) to the vibration film 131 and approximately 50% of the laser beam Lout going forward to the reference optical path (the first optical path) to the reflecting plate 141. Thereby, the laser beam Lout is split into the P-polarized component p0 traveling along the reflection optical path and the S-polarized component s0 (the reference beam) traveling along the reference optical path. In other words, the beam of the S-polarized component is reflected by the polarizing beam splitter 12, and the beam of the P-polarized component passes through the polarizing beam splitter 12.

In this case, when the P-polarized component p0 passes through the λ/4 plate 151, the P-polarized component p0 is changed from linear polarization to circular polarization, and after that, when the P-polarized component p0 is reflected by the vibration film 131, the P-polarized component p0 is changed to reverse circular polarization, and passes through the λ/4 plate 151 again, thereby the P-polarized component p0 is converted into the S-polarized component s1 (the reflected beam). Then, the S-polarized component s1 is reflected by the polarizing beam splitter 12 as described above, so the S-polarized component s1 goes forward to the beam splitter 16 along the reflection optical path. On the other hand, when the S-polarized component s0 as the reference beam passes through the λ/4 plate 152, the S-polarized component s0 is changed from linear polarization to circular polarization, and after that, when the S-polarized component s0 is reflected by the reflecting plate 141, the S-polarized component s0 is changed to reverse circular polarization, and passes through the λ/4 plate 152 again, thereby the S-polarized component s0 is converted into the P-polarized component p1. Then, the P-polarized component p1 passes through the polarizing beam splitter 12 as described above, so the P-polarized component p1 goes forward to the beam splitter 16 along the reference optical path. At this time, the S-polarized component s1 and the P-polarized component p1 which travel along the same optical paths (the reflection optical path and the reference optical path) have polarization directions different by 90° from each other, so they do not interfere with each other.

Next, the S-polarized component s1 and the P-polarized component p1 which travel along the reflection optical path and the reference optical path are split into approximately 50% of each of the S-polarized component s1 and the P-polarized component p1 going forward to an optical path to the polarizing plate 171 and approximately 50% of each of the S-polarized component s1 and the P-polarized component p1 going forward to an optical path to the polarizing plate 172, and they travel along the optical paths to reach the polarizing plates 171 and 172. At this time, the λ/4 plate 153 is inserted in the middle of the optical path to the polarizing plate 171, so the S-polarized component s1 and the P-polarized component p1 which reach the vibrating plate 171 and the S-polarized component s1 and the P-polarized component p1 which reach the vibrating plate 172 have phases different by 90° from each other. The polarizing plates 171 and 172 each have a polarizing axis in a direction inclined 45° from each of the polarization direction of the S-polarized component s1 and the polarization direction of the P-polarized component p1, so in the embodiment in which the phases of the S-polarized component s1 and the P-polarized component p1 are different by 90° from each other, the S-polarized component s1 and the P-polarized component p1 of the reference beam interfere with each other in the polarizing plates 171 and 172 to form the interference patterns.

Next, the interference patterns formed on the polarizing plates 171 and 172 are detected by the photoelectric conversion devices 181 and 182, respectively. In this case, as described above, the S-polarized component s1 and the P-polarized component p1 which reach the vibrating plate 171 and the S-polarized component s1 and the P-polarized component p1 which reach the vibrating plate 172 have phases different by 90° from each other, so in the photoelectric conversion devices 181 and 182, the interference patterns are detected in a state in which the phases thereof are different by 90° from each other. Then, the interference pattern detected by the photoelectric conversion device 181 is converted into an electrical signal, and the electrical signal is outputted as the output signal Sx, and on the other hand, the interference pattern detected by the photoelectric conversion device 182 is converted into an electrical signal, and the electrical signal is outputted as the output signal Sy.

Next, in the digital counting section 19, the output signals Sx and Sy from the photoelectric conversion devices 181 and 182 are considered as an X signal and a Y signal, respectively, and, for example, a lissajous figure with a circular or arc shape shown in FIG. 4 is produced. More specifically, assuming that the amplitudes of interfering beams from two optical paths are A and B, an optical path difference is ΔL, and a wavelength is λ, the intensities Ix and Iy of the interfering beams are represented by the following formulas (1) to (3). Then, x and y signals are obtained from the output signals Sx and Sy by outputting signals X and Y according to the intensities Ix and Iy of the interfering beams, and canceling DC component signals CX and CY corresponding to A²+B² as an DC component of light intensity, and further passing the output signals Sx and Sy through an amplifier (not shown) having a gain G′ corresponding to a light intensity gain G represented by the following formula (4). Thus, when the computation of the following formulas (5) and (6) is performed, a (x, y) signal is obtained from a (X, Y) signal.

Ix=A²+B²+2AB cos θ (1)

Iy=A²+B²+2AB sin θ (2)

θ=(2π×ΔL)λ (3)

G=1/(2AB) (4)

x=(X−CX)×G′=cos θ (5)

y=(Y−CY)×G′=sin θ (6)

Then, by the computation of the above-described formulas (5) and (6), from the movement of a signal point (x, y), as shown in FIG. 4, a lissajous figure in which the signal point (x, y) rotates on the circumference of a circle around a central point C is possible to be obtained. At this time, a detection point (for example, a signal point P0 in the drawing) detected by the photoelectric conversion devices 181 and 182 is one point on the circumference of the circle, and the detection point is displaced on the circumference of the circle according to the displacement of the vibration film 131. Therefore, by θ=arctan(y/x), an angle θ is uniquely determined in an angle range (a range from −π/2 to +π/2) from the values of x and y, and in the case where the angle θ exceeds the upper limit of the range, 1 is added to the value of an accumulator, and in the case where the angle θ exceeds the lower limit of the range, 1 is subtracted from the value of the accumulator. The counted number is outputted as the audio signal Sout which is a digital signal as information of the angle θ.

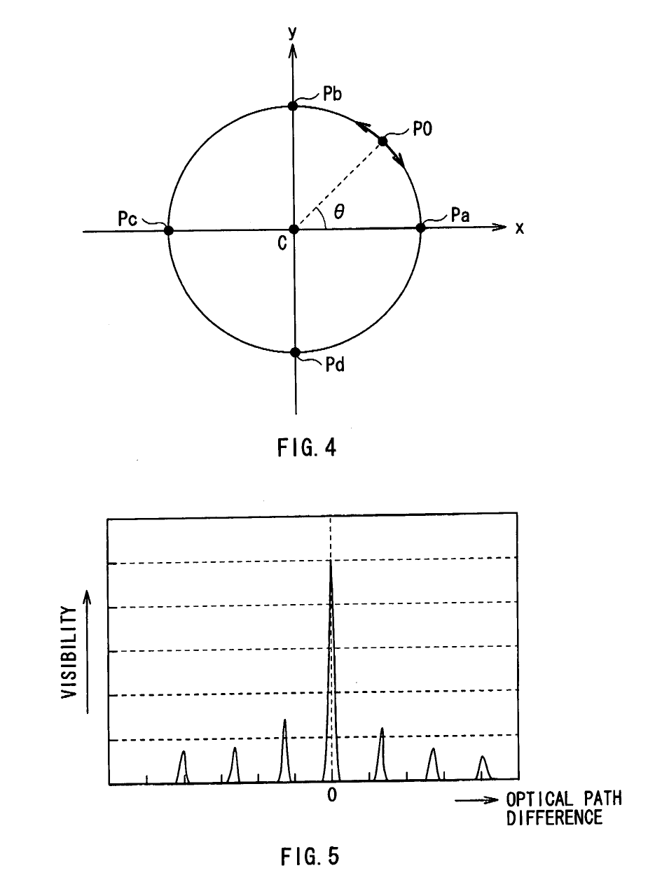

Next, referring to FIGS. 5 to 7 in addition to FIGS. 1 to 4, the operation of a characteristic part (multiple reflections between the vibration film 131 and the half mirror 142) of the embodiment of the invention will be described in detail below.

At first, the intensity I of an interference pattern by the interference of the reference beam and the reflected beam is represented by the following formula (7) from the above-described formulas (1) to (3). Moreover, ΔL in the formula (3) represents the displacement of an optical path difference between the reference beam and the reflected beam, so assuming that the displacement of the vibration film 131 by the sonic wave Sw is δ, and the incident angle of the laser beam Lout to the vibration film 131 is θ, the displacement ΔL of the optical path difference is represented by the following formula (8).

I=A²+B²+2AB cos((2π×ΔL)/λ) (7)

ΔL=2×δ×cos θ (8)

At this time, in the interferometer according to the embodiment, a part of the reflected beam reflected by the vibration film 131 is reflected by the half mirror 142 to return to a direction toward the vibration film 131, so the multiply reflected beam Lr shown in FIG. 1 is generated. Therefore, assuming that the incident angle of such a multiply reflected beam Lr to the vibration film 131 is θ1 (an incident angle at the first reflection), θ2 (an incident angle at the second reflection), . . . , and θn (an incident angle at the nth reflection), the displacement ΔL of the above-described optical path difference is represented by the following formula (9). By the formula (9), in the case where the incident angle is around 0° (in the case where a laser beam almost vertically enters into the vibration film 131), cos θ1=cos θ2= . . . =cos θn≈1 is established, so the displacement ΔL of the optical path difference is represented by the following formula (10), and the displacement ΔL of the optical path difference is almost equal to a value multiplied by the multiple reflection number n of the laser beam Lout between the vibration film 131 and the half mirror 142 (the displacement ΔL of the optical path difference increases by approximately n times). Therefore, it is found out that the optical path difference is increased by multiple reflections between the vibration film 131 and the half mirror 142, thereby the displacement of the vibration film 131 is amplified to be detected.

ΔL=2×δ×(cos θ1+cos θ2+ . . . +cos θn) (9)

ΔL≈2×δ×n (10)

Moreover, in particular, in the case where, for example, a laser source emitting a low-coherence beam such as a self-pulsation laser diode is used as the laser source 10, for example, as shown in FIG. 5, when the optical path difference between the reference beam and the reflected beam is 0, the visibility of the interference pattern reaches its maximum, and when the optical path difference is generated, the visibility rapidly declines. Assuming that the maximum of the intensity I of the interference pattern is Imax, and the minimum of the intensity I of the interference pattern is Imin, the visibility of the interference pattern is defined by the following formula (II).

Visibility of interference pattern=(Imax−Imin)/(Imax+Imin) (11)

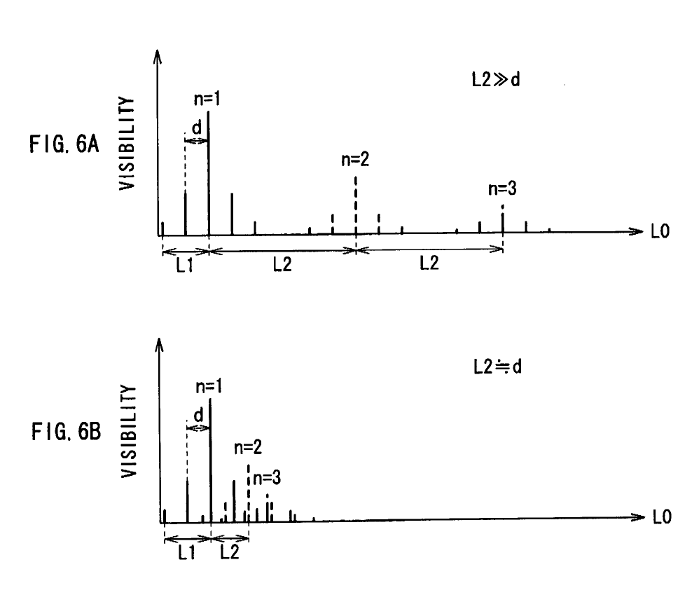

At this time, as described above, in the case where the multiple reflection number of the laser beam Lout between the vibration film 131 and the half mirror 142 is n, assuming that a distance between the beam splitter 12 and the vibration film 131 is L1, and a distance between the vibration film 131 and the half mirror 142 is L2 as described above, the distance L0 between the beam splitter 12 and the reflecting plate 141 when the visibility of the interference pattern formed by the interference of an n-times reflected beam which is reflected n times and the reference beam reaches its maximum is represented by the following formula (12). Therefore, positions of an interfering beam peak and a side peak are, for example, as shown in FIGS. 6A and 6B, where the horizontal axis represents the distance L0 between the beam splitter 12 and the reflecting plate 141 in FIGS. 6A and 6B, when the visibility of the interference pattern is at its the maximum.

L0=L1+(n−1)×L2 (12)

In other words, the reflected beam in the reflection optical path includes a plurality of reflection components with different reflection numbers caused by multiple reflections between the vibration film 131 and the half mirror 142 (for example, reflection components represented by n=1, n=2, n=3, . . . in FIGS. 6A and 6B), so when the distance L0 between the beam splitter 12 and the reflecting plate 141 is set to be L0 represented by the above-described formula (12), in other words, when the distance L0 (and the distances L1 and L2) is set so that the optical path length of the reflection optical path by a reflection component with a desired reflection number and the optical path length of the reference optical path are substantially equal to each other, selective interference between the reflection component with a desired reflection number and the reference beam is possible to occur, and the visibility of the interference pattern by the interference reaches its maximum.

Further, for example, as shown in FIG. 6A, in the case where L2 is much greater than d (d: a distance between visibility peaks of interference patterns), visibility peaks of the interference patterns by a plurality of reflection components with different reflection number appear in positions away from one another on the distance L0, so the visibility peaks of the interference patterns do not exert an influence on each other such as interference with each other. However, for example, as shown in FIG. 6B, in the case of L2≈d, the visibility peaks of the interference patterns by a plurality of reflection components with different reflection numbers appear in positions close to one another on the distance L0, so in this state, due to interference of the visibility peaks of the interference patterns with each other, it is difficult to detect selective interference between a reflection component with a desired reflection number and the reference beam.

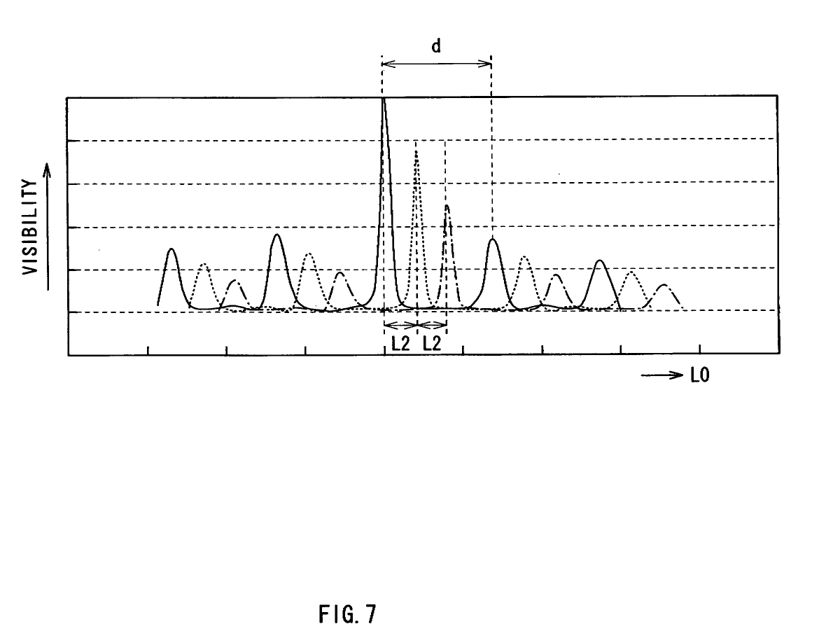

Therefore, in such a case, for example, as shown in FIG. 7, when the distance L2 is set so that L2≈(d/n) is established, the influence by the interference of the visibility peaks of the interference patterns with each other by a plurality of reflection components with different reflection numbers is possible to be minimized. Thereby, it is easier to individually detect the visibility peak of each interference pattern, so the detection accuracy of the displacement of the vibration film 131 is improved.

As described above, in the microphone apparatus 1 according to the embodiment, the laser beam Lout emitted from the light source 10 is split into two components traveling along two optical paths (the reference optical path and the reflection optical path) by the polarizing beam splitter 12 in the interferometer, and the components travel as the S-polarized component s0 and the P-polarized component p0. At this time, the reference beam (the P-polarized component p1) reflected by the reflecting plate 141 in the reference optical path, and the reflected beam (the S-polarized component s1) reflected by the vibration film 131 and the half mirror 142 in the reflection optical path interfere with each other to form the interference patterns in the polarizing plates 171 and 172. Then, on the basis of the interference patterns, the vibration of the vibration film 131 is detected as the quantized audio signal Sout by the photoelectric conversion devices 181 and 182 and the digital signal processing section 19. In this case, the above-described reflected beam is a beam multiply reflected between the vibration film 131 and the half mirror 142 in the reflection optical path, so the optical path difference between the reference beam and the reflected beam is increased, thereby the displacement of the vibration film 131 is amplified to be detected.

As described above, in the embodiment, the laser beam Lout from the light source 10 is split into two components traveling along two optical paths (the reference optical path and the reflection optical path) in the interferometer, and the reference beam reflected by the reflecting plate 141 in the reference optical path and the reflected beam reflected by the vibration film 131 and the half mirror 142 in the reflection optical path interfere with each other to form the interference patterns, and on the basis of the interference patterns, the vibration of the vibration film 131 is detected, so the vibration of the vibration film 131 is possible to be optically detected. Moreover, the above-described reflected beam is a beam which is multiply reflected between the vibration film 131 and the half mirror 142 in the reflection optical path, so the optical path difference between the reference beam and the reflected beam is possible to be increased, and the displacement of the vibration film 131 is possible to be amplified to be detected. Therefore, when vibration detection is optically performed, detection sensitivity may be improved.

Further, the Michelson interferometer is used as the interferometer, so the microphone apparatus with a small and simple configuration may be achieved. Therefore, in the vibration detection device (the microphone apparatus) optically performing digital vibration detection, the size of the apparatus may be reduced.

Moreover, non-contact sensing by light is possible to be performed, so the size or the weight of the vibration film 131 may be freely selected, and the dynamic range and frequency characteristics may be expanded, compared to an analog system such as a dynamic system or a capacitor system in related arts.

Further, the digital signal is possible to be directly captured by counting the number of the interference patterns, so when angle detection accuracy is increased, an S/N ratio may be easily reduced, and a reduction in the noise of the audio signal Sout to be outputted may be achieved. Moreover, the digital signal is possible to be obtained directly from the microphone apparatus 1, so digital transmission may be easily achieved, and even in the case where a long cable is drawn from the microphone apparatus 1, an influence such as noise may be prevented.

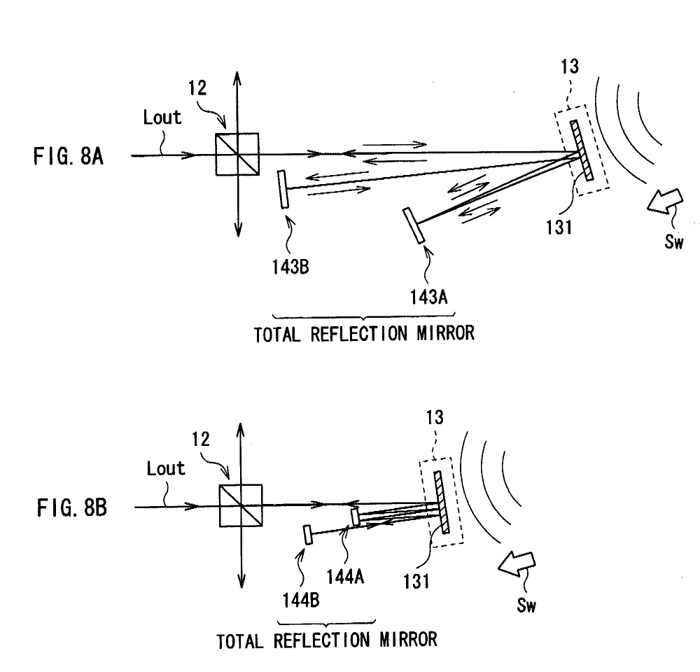

In the embodiment, as an example of the second reflection body capable of at least partially reflecting the laser beam Lout, the half mirror 142 capable of partially reflecting the laser beam Lout and partially passing the laser beam Lout therethrough is described; however, for example, as shown in FIGS. 8A and 8B, an interferometer may be formed through the use of a total reflection mirror reflecting the whole laser beam Lout (total reflection mirrors 143A and 143B shown in FIG. 8A, total reflection mirrors 144A and 144B shown in FIG. 8B or the like). In such a configuration, a decline in light intensity at the time of reflection is prevented, so in addition to effects in the above-described embodiment, the detection accuracy of the interference pattern may be improved so as to improve the detection accuracy of the vibration film 131.

### Second Embodiment

Next, a second embodiment of the invention will be described below. Like components are denoted by like numerals as of the first embodiment and will not be further described.

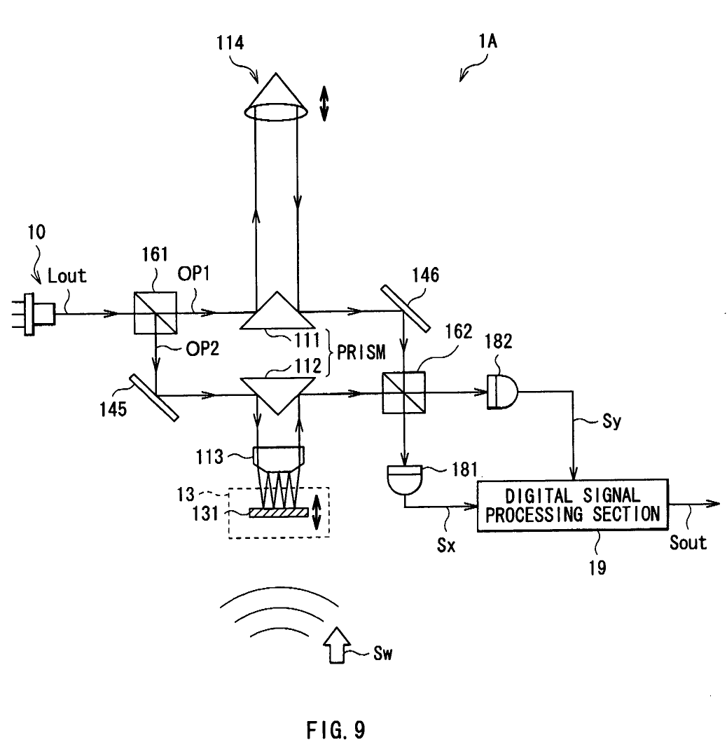

FIG. 9 shows the configuration of a vibration detection device (microphone apparatus 1A) according to the embodiment. The microphone apparatus 1A includes a Mach-Zehnder interferometer as an interferometer. More specifically, the microphone apparatus 1A includes the laser source 10, the Mach-Zehnder interferometer, and a detection section including two photoelectric conversion devices 181 and 182 and the digital signal processing section 19. Moreover, the Mach-Zehnder interferometer includes a beam splitter 161, two reflective mirrors 145 and 146, three prisms 111 to 113, a corner cube prism 114 and a beam splitter 162.

The beam splitter 161 splits the laser beam Lout emitted from the laser source 10 into a beam traveling along a first optical path OP1 (a reference optical path) to the prism 111 and a beam traveling along a second optical path OP2 (a reflection optical path) to the reflective mirror 145.

The reflective mirror 145 is arranged on the optical path OP2, and reflects the laser beam Lout traveling along the optical path OP2 toward the prism 112.

The prism 111 is arranged on the optical path OP1, and reflects the laser beam Lout (the reference beam) traveling from the beam splitter 161 on the optical path OP1 toward the corner cube prism 114, and reflects the laser beam Lout (the reference beam) traveling from the corner cube prism 114 on the optical path OP1 toward the reflective mirror 146.

The prism 112 reflects the laser beam Lout reflected by the reflective mirror 145 toward the prism 113 and the vibration film 131, and as will be described below, the prism 112 reflects a reflected beam multiply reflected by the vibration film 131 and the prism 113 toward the beam splitter 162.

The prism 113 has a reflective surface formed by metal-evaporating a surface on a side closer to the vibration film 131, and multiply reflects the laser beam Lout traveling along the optical path OP2 between the vibration film 131 and the prism 113.

The corner cube prism 114 is arranged on the optical path OP1, and reflects the laser beam Lout (the reference beam) reflected by the prism 111 to make the laser beam Lout go forward to the prism 111 again. As shown by an arrow in FIG. 9, the position of the corner cube prism 114 is possible to be freely displaced, thereby as in the case of the first embodiment, the optical path length of the reference optical path may be freely adjusted.

The reflective mirror 146 is arranged on the optical path OP1, and reflects the laser beam Lout (the reference beam) reflected by the prism 111 toward the beam splitter 162.

The beam splitter 146 splits the reference beam entering from the optical path OP1 and a reflected beam (a multiply reflected beam) entering from the optical path OP2 into a part of each of the reference beam and the reflected beam going forward to an optical path to the photoelectric conversion device 181 and a part of each of the reference beam and the reflected beam going forward to an optical path to the photoelectric conversion device 182.

The corner cube prism 114 corresponds to a specific example of “a first reflection body” in the invention, and the prism 113 corresponds to a specific example of “a second reflection body” and “a total reflection mirror” in the invention.

By such a configuration, in the interferometer according to the embodiment, the laser beam Lout emitted from the laser source 10 is split into two beams traveling along the optical paths OP1 and OP2 by the beam splitter 161. More specifically, the laser beam Lout is split into a beam going forward to the first optical path (the reference optical path) passing through the beam splitter 161, the prism 111, the corner cube prism 114, the prism 111, the reflective mirror 146 and the beam splitter 162 and a beam going forward to the second optical path (the reflection optical path) passing through the beam splitter 161, the reflective mirror 145, the prism 112, the prism 113, the vibration film 131, the prism 112 and the beam splitter 162. At this time, the reflected beam reflected by the vibration film 131 and the prism 113 in the reflection optical path and the reference beam reflected by the corner cube prism 114 in the reference optical path interfere with each other in the beam splitter 162 to from the interference patterns. Therefore, on the basis of the interference patterns, the vibration of the vibration film 131 is detected by the photoelectric conversion devices 181 and 182 and the digital signal processing section 19 as the quantized audio signal Sout as in the case of the first embodiment.

Moreover, the above-described reflected beam is a beam multiply reflected between the vibration film 131 and the prism 113 in the reflection optical path, so an optical path difference between the reference beam and the reflected beam is increased, thereby the displacement of the vibration film 131 is amplified to be detected.

Therefore, in the embodiment, the same effects as those in the first embodiment may be obtained by the same functions as those in the first embodiment. In other words, when vibration detection is optically performed, detection sensitivity may be improved.

Moreover, as the interferometer, the Mach-Zehnder interferometer is used, so the generation of a return beam to the laser source 10 from the laser beam Lout may be prevented without using high-priced optical parts such as a wave plate or a polarizing beam splitter, and noises in the laser source 10 may be prevented at low cost.

Although the present invention is described referring to the first and second embodiments, the invention is not limited to them, and may be variously modified.

For example, the counting number of angle separations relative to a uniquely determined angle within a range of −(π/2)<θ<+(π/2) of the lissajous figure described in the above embodiments may be increased. In such a configuration, the detection sensitivity may be improved by increasing angle resolution.

Moreover, in the above-described embodiments, the laser diode is described as the light source emitting the laser beam Lout; however, except for the laser diode, for example, a gas laser, a solid-state laser or the like may be used.

Further, in the above-described embodiments, as an example of the vibration detection device according to the embodiments of the invention, the optical microphone apparatus in which the vibrating body is the vibration film (the vibration film 131) vibrating in response to a sonic wave, and the vibration of the vibration film 131 is detected as the audio signal Sout is described; however, the vibration detection device according to the embodiments of the invention is not limited to this, and may be configured to detect other vibrations.

In addition, in the above-described embodiments, the case where the vibration of the vibration film 131 is digitally detected as the quantized signal Sout through the use of the digital counting section 19 is described; however, the vibration of the vibration film may be directly outputted as an analog signal. More specifically, for example, when the output signals Sx and Sy from the photoelectric conversion devices 181 and 182 are used in a region where interfering beam intensity is linearly changed, an electrical signal substantially proportional to the displacement of a vibrating plate is possible to be obtained, so the signal may be directly outputted as an analog audio signal. According to a well-known system, when an optical path length on the reference beam side is configured to be movable by using a piezoelectric element or the like, and the negative feedback on a DC component of an output signal is performed onto the piezoelectric element, the interfering beam intensity is controlled to be change in a linear region. It should be understood by those skilled in the art that various modifications, combinations, sub-combinations and alterations may occur depending on design requirements and other factors insofar as they are within the scope of the appended claims or the equivalents thereof.

What is claimed is:

1. A vibration detection device comprising:
a light source emitting a laser beam;
an interferometer including a vibrating body and a first reflection body both capable of reflecting the laser beam, and a second reflection body capable of at least partially reflecting the laser beam, the interferometer splitting the laser beam emitted from the light source into beams traveling along first and second optical paths, the interferometer causing interference between a reference beam reflected by the first reflection body in the first optical path and reflected beams multiply reflected between the vibrating body and the second reflection body in the second optical path to form interference patterns; and
a detection means for detecting the vibration of the vibrating body on the basis of the formed interference patterns.

2. The vibration detection device according to claim 1, wherein
the second reflection body is a half mirror partially reflecting the laser beam, and partially passing the laser beam therethrough.

3. The vibration detection device according to claim 2, wherein
the reflected beams include a plurality of reflection components with different reflection numbers caused by multiple reflections between the vibrating body and the second reflection body, and
the optical path length of the second optical path for a reflection component with a desired reflection number among the plurality of reflection components with different reflection numbers is set so as to be equal to the optical path length of the first optical path.

4. The vibration detection device according to claim 2, wherein
the reflected beams include a plurality of kinds of reflection components of which the reflection numbers caused by multiple reflections between the vibrating body and the second reflection body are different, and
the optical path length of the first optical path is set so that the visibility peaks of the interference patterns caused by the interference between the reference beam and the plurality of reflection components are separated from each other.

5. The vibration detection device according to claim 1, wherein
the second reflection body includes a total reflection mirror reflecting the whole laser beam.

6. The vibration detection device according to claim 1, wherein
the interferometer is a Michelson interferometer.

7. The vibration detection device according to claim 1, wherein
the interferometer is a Mach-Zehnder interferometer.

8. The vibration detection device according to claim 1, wherein
the detection means includes:
a couple of photoelectric conversion devices each detecting the interference pattern with a phase different by 90° from a phase of the interference pattern detected by another photoelectric conversion device;
a figure producing means producing a lissajous figure with a circular or arc shape on a plane based on a pair of output signals from the couple of photoelectric conversion devices; and
a counter counting the number of times where a signal point defined by the pair of output signals passes through a predetermined reference point on the produced lissajous figure.

9. The vibration detection device according to claim 1, wherein
the vibrating body is a vibration film vibrating in response to a sonic wave, and the vibration detection device is configured as an optical microphone apparatus detecting the vibration of the vibration film as a quantized audio signal.

10. A vibration detection device comprising:
a light source emitting a laser beam;
an interferometer including a vibrating body and a first reflection body both capable of reflecting the laser beam, and a second reflection body capable of at least partially reflecting the laser beam, the interferometer splitting the laser beam emitted from the light source into beams traveling along first and second optical paths, the interferometer causing interference between a reference beam reflected by the first reflection body in the first optical path and reflected beams multiply reflected between the vibrating body and the second reflection body in the second optical path to from interference patterns; and
a detection section detecting the vibration of the vibrating body on form interference patterns; and
the basis of the formed interference patterns.
